(19) United States
(12) Patent Application Publication
(10) Pub. No.: US 2013/0039690 A1
(43) Pub. Date: Feb. 14, 2013

(54) HIDDEN FIXING DEVICE FOR BIKE AUXILIARY HANDLE

(71) Applicants: Yi-Fen Wu, Taichung City (TW); Chen-Kuei Wu, Taichung City (TW)

(72) Inventors: Yi-Fen Wu, Taichung City (TW); Chen-Kuei Wu, Taichung City (TW)

(21) Appl. No.: 13/234,527

(22) Filed: Sep. 16, 2011

(30) Foreign Application Priority Data
Aug. 12, 2011 (TW) 100215060

(51) Int. Cl. B62K 21/18

(52) U.S. Cl. 403/188

(57) ABSTRACT

A hidden fixing device for a bike auxiliary handle includes a main seat and an auxiliary handle portion. The auxiliary handle fixing portion includes an auxiliary handle fixing passage and an auxiliary handle fixing unit. The auxiliary handle fixing unit is disposed at a side of the auxiliary handle fixing passage. The locking member is inserted through the threaded hole of the second fastening member and the displacement hole and screwed to the threaded hole of the first fastening member, so that the first and second fastening members are engaged with each other and the first and second fastening sides extend into the auxiliary handle fixing passage to fasten the auxiliary handle.

### BACKGROUND OF THE INVENTION

1. Field of the Invention

The present invention relates to a hidden fixing device for a bike auxiliary handle, and more particularly to a fixing device which is pleasing to the eye and won't be damaged easily.

2. Description of the Prior Art

A conventional bike auxiliary handle fixing device (referring to TW Utility Model Patent No. M397943, titled “COMBINED FIXING SEAT OF BIKE HANDLE AND AUXILAIRYT HANDLE AND PAD SEAT”) comprises a main handle with an exposed through hole seat for insertion of an auxiliary handle. The through hole seat has a threaded hole at a circumferential portion for insertion of a bolt to fix the auxiliary handle. The conventional fixing device has the following shortcomings.

1. The exposed structure is unable to lower wind resistance. The conventional bike auxiliary handle fixing device has an exposed configuration, which cannot comply with to the demand of the professional contest because it is unable to lower wind resistance. When it is used to an expensive bike, it will influence the quality of the bike.

2. It is easy to be damaged. When the bike topples down, the conventional bike auxiliary handle fixing device may be damaged due to collision. Though it can be repaired, it may slant and cannot secure the auxiliary handle firmly.

Accordingly, the inventor of the present invention has devoted himself based on his many years of practical experiences to solve these problems.

### SUMMARY OF THE INVENTION

The primary object of the present invention is to provide a hidden fixing device for a bike auxiliary handle which is pleasing to the eye and won't be damaged easily.

In order to achieve the aforesaid object, the hidden fixing device for a bike auxiliary handle of the present invention comprises a main seat and an auxiliary handle fixing portion.

The main seat has a main handle fixing portion. The main handle fixing portion is used to connect a main handle.

The auxiliary handle fixing portion comprises an auxiliary handle fixing passage and an auxiliary handle fixing unit.

The auxiliary handle fixing passage is adapted for insertion of an auxiliary handle. The auxiliary handle fixing portion has a first accommodation recess and a second accommodation recess at front and rear ends of a side of the auxiliary handle fixing passage and a displacement hole which is disposed between the first and second accommodation recesses.

The auxiliary handle fixing unit comprises a first fastening member, a second fastening member and a locking member.

The first fastening member has a first threaded hole and a first fastening side. The first fastening member is inserted into the first accommodation recess at the front end of the side of the auxiliary handle fixing passage.

The second fastening member has a second threaded hole and a second fastening side. The second fastening member is inserted into the second accommodation recess at the rear end of the side of the auxiliary handle fixing passage.

The locking member is inserted through the second threaded hole of the second fastening member and the displacement hole and screwed to the first threaded hole of the first fastening member, so that the first and second fastening members are engaged with each other and the first and second fastening sides extend into the auxiliary handle fixing passage to fasten the auxiliary handle.

### BRIEF DESCRIPTION OF THE DRAWINGS

FIG. 1 is an exploded view according to a preferred embodiment of the present invention;

FIG. 2 is another exploded view showing the sectional auxiliary handle fixing portion according to the preferred embodiment of the present invention;

FIG. 3 is a perspective view according to the preferred embodiment of the present invention;

FIG. 4 is another perspective view according to the preferred embodiment of the present invention;

FIG. 5 is a vertically sectional view of FIG. 3;

FIG. 6 is a vertically sectional view of FIG. 3 in an operating state;

FIG. 7 is a transversely sectional view of FIG. 3;

FIG. 8 is a transversely sectional view of FIG. 3 in an operating state; and

FIG. 9 is a perspective view according to the preferred embodiment of the present invention when in use.

### DETAILED DESCRIPTION OF THE PREFERRED EMBODIMENTS

Embodiments of the present invention will now be described, by way of example only, with reference to the accompanying drawings.

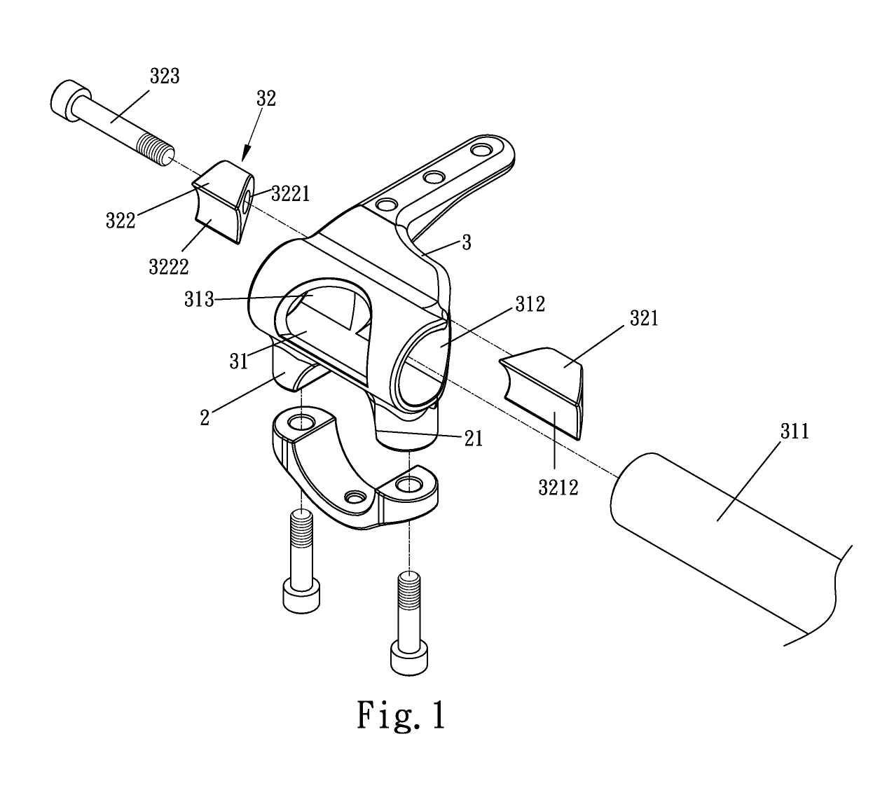

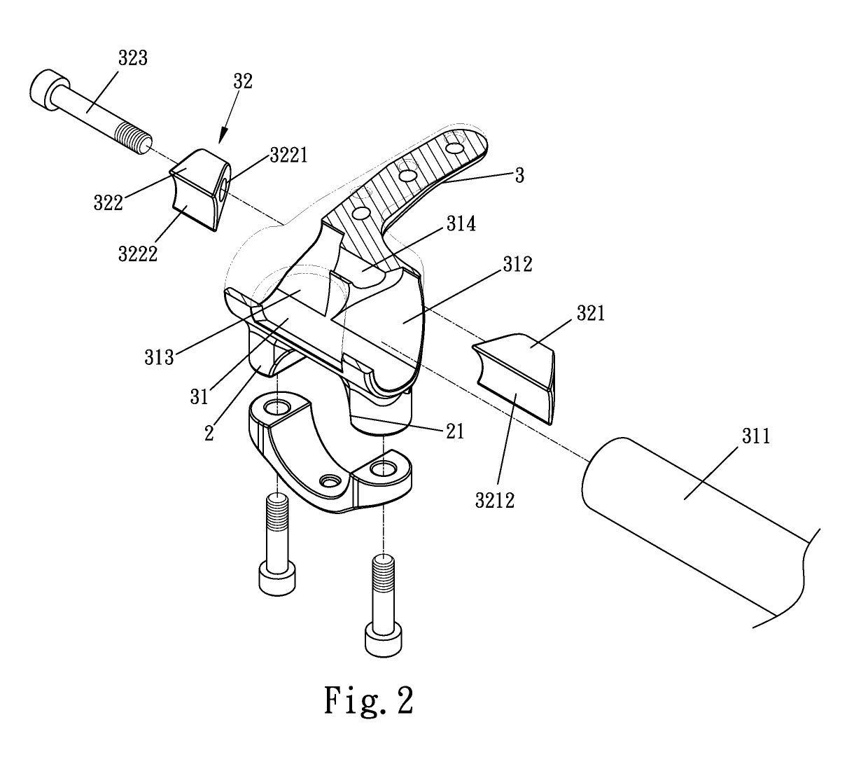

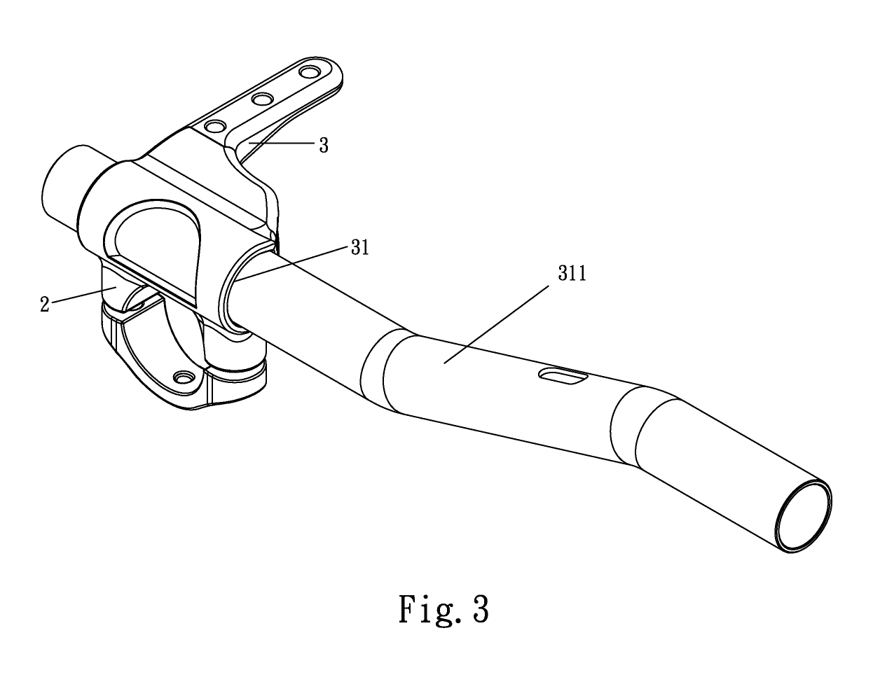

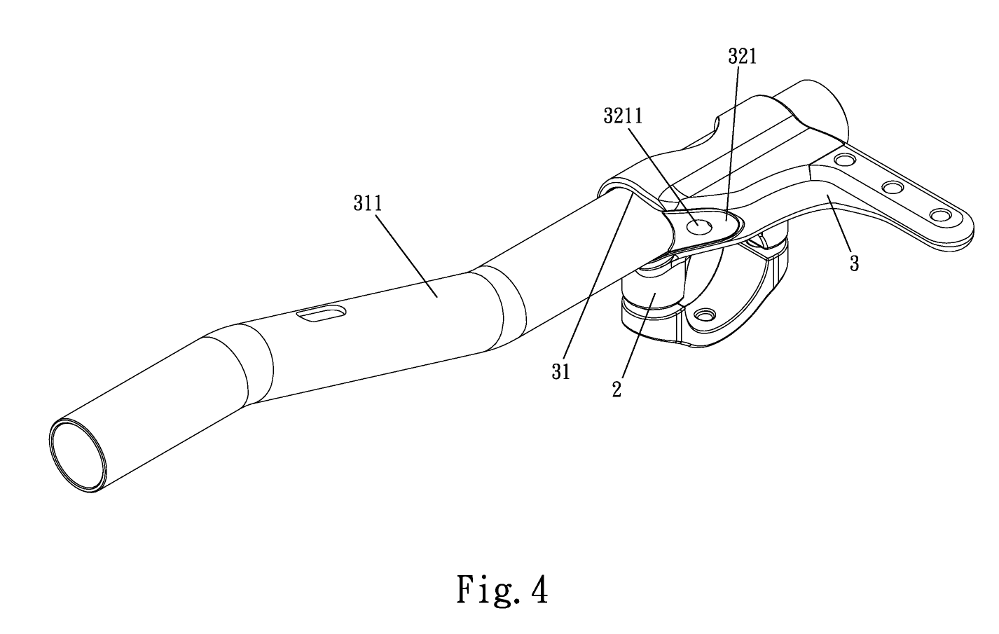

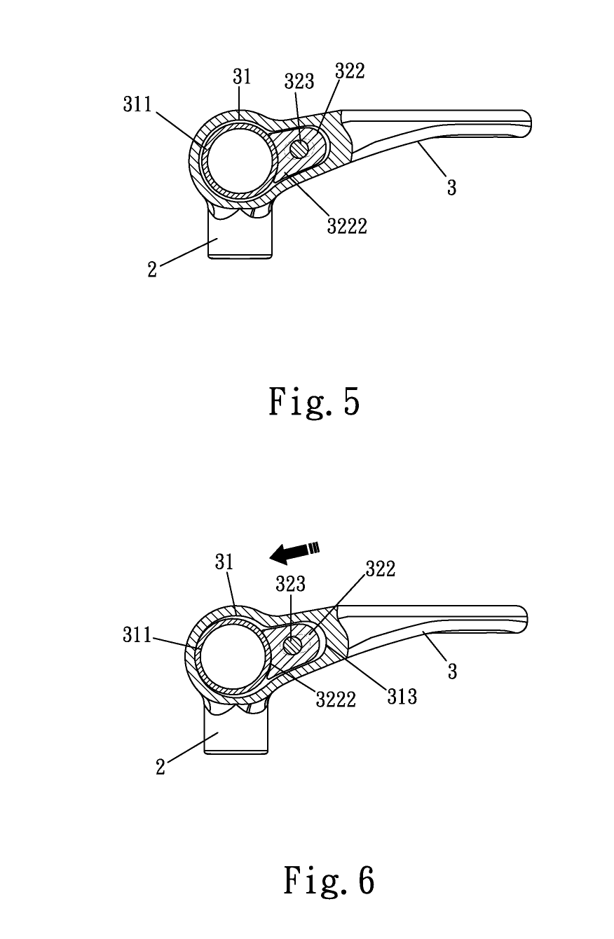

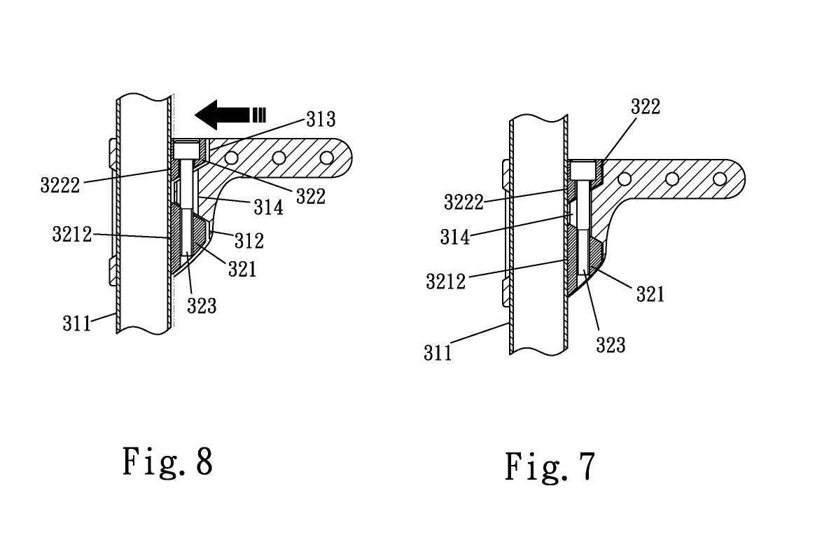

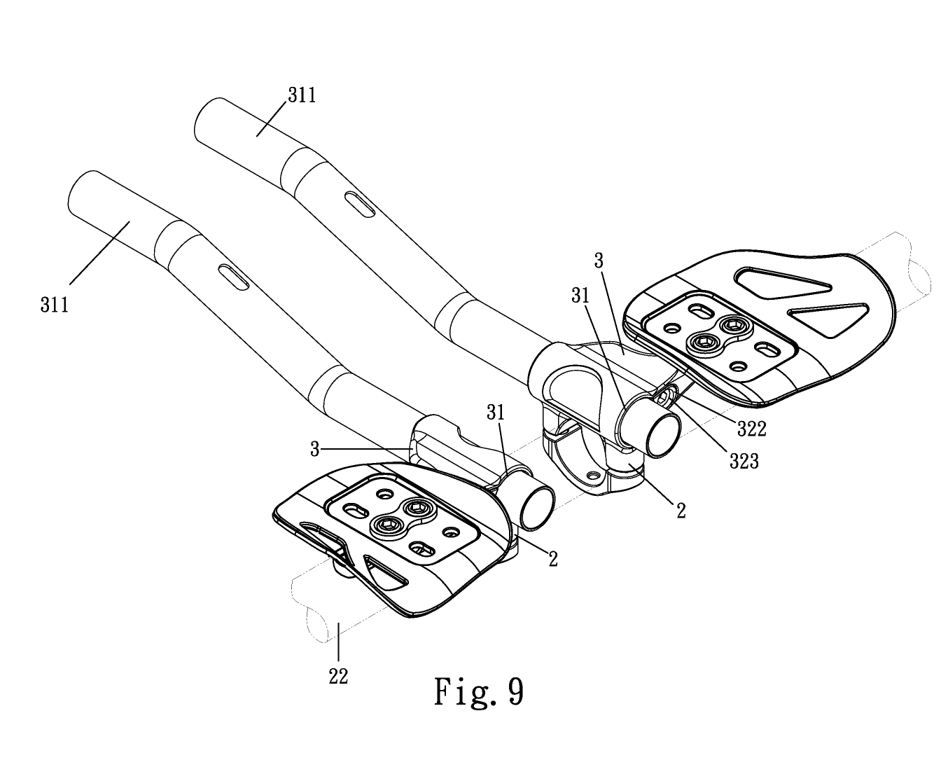

As shown in FIG. 1 through FIG. 9, the hidden fixing device for a bike auxiliary handle according to a preferred embodiment of the present invention comprises a main seat 2 and an auxiliary handle fixing portion 3.

The main seat 2 has a main handle fixing portion 21. The main handle fixing portion 21 is used to connect a main handle 22.

The auxiliary handle fixing portion 3 comprises an auxiliary handle fixing passage 31 and an auxiliary handle fixing unit 32.

The auxiliary handle fixing passage 31 is adapted for insertion of an auxiliary handle 311. The auxiliary handle fixing portion 3 has a first accommodation recess 312 and a second accommodation recess 313 at front and rear ends of a side of the auxiliary handle fixing passage 31 and an oval-shaped displacement hole 314 which is disposed between the first and second accommodation recesses 312, 313.

The auxiliary handle fixing unit 32 comprises a first fastening member 321, a second fastening member 322, and a locking member 323.

The first fastening member 321 has a first threaded hole 3211 and a first fastening side 3212. The first fastening member 321 is inserted into the first accommodation recess 312 at the front end of the side of the auxiliary handle fixing passage 31.

The second fastening member 322 has a second threaded hole 3221 and a second fastening side 3222. The second fastening member 322 is inserted into the second accommodation recess 313 at the rear end of the side of the auxiliary handle fixing passage 31.

The locking member 323 is inserted through the second threaded hole 3221 of the second fastening member 322 and the oval-shaped displacement hole 314 and screwed to the first threaded hole 3211 of the first fastening member 321, so that the first and second fastening members 321, 322 are engaged with each other and the first and second fastening sides 3212, 3222 extend into the auxiliary handle fixing passage 31 to fasten the auxiliary handle 311.

To assemble the present invention, the first fastening member 321 and the second fastening member 322 of the auxiliary handle fixing unit 32 are respectively inserted into the first accommodation recess 312 and the second accommodation recess 313 at the front and rear ends of the side of the auxiliary handle fixing passage 31. The locking member 323 is inserted through the second threaded hole 3221 of the second fastening member 322 and the displacement hole 314 and screwed to the first threaded hole 3211 of the first fastening member 321. Then, the auxiliary handle 311 is inserted in the auxiliary handle fixing passage 31. The oval-shaped displacement hole 314 is located between the first and second accommodation recesses 312, 313 at the front and rear ends of the side of the auxiliary handle fixing passage 31. When the locking member 323 is inserted into the second threaded hole 3221 of the second fastening member 322 and the first threaded hole 3211 of the first fastening member 321, the first and second fastening members 321, 322 are engaged with each other and the first and second fastening sides 3212, 3222 of the first and second fastening members 321, 322 extend into the auxiliary handle fixing passage 31 to fasten the auxiliary handle 311.

The present invention has the following advantages.

1. The hidden configuration is pleasing to the eye to enhance its quality. The first fastening member, the second fastening member and the locking member of the auxiliary handle fixing unit are all hidden in the first and second accommodation recesses of the auxiliary handle fixing passage, so the auxiliary handle fixing unit is an integral whole and is in a streamline form to enhance its quality and to lower wind resistance.

2. It won't be damaged easily. The entire structure of the auxiliary handle fixing unit is received in in the first and second accommodation recesses of the auxiliary handle fixing passage. When the bike topples down, the auxiliary handle fixing unit won't be damaged easily.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A hidden fixing device for a bike auxiliary handle, comprising:
a main seat having a main handle fixing portion, the main handle fixing portion being used to connect a main handle;
an auxiliary handle fixing portion comprising an auxiliary handle fixing passage and an auxiliary handle fixing unit;
the auxiliary handle fixing passage being adapted for insertion of an auxiliary handle, the auxiliary handle fixing portion having a first accommodation recess and a second accommodation recess at front and rear ends of a side of the auxiliary handle fixing passage and a displacement hole which is disposed between the first and second accommodation recesses;
the auxiliary handle fixing unit comprising a first fastening member, a second fastening member and a locking member;
the first fastening member having a first threaded hole and a first fastening side, the first fastening member being inserted into the first accommodation recess at the front end of the side of the auxiliary handle fixing passage;
the second fastening member having a second threaded hole and a second fastening side, the second fastening member being inserted into the second accommodation recess at the rear end of the side of the auxiliary handle fixing passage;
the locking member being inserted through the second threaded hole of the second fastening member and the displacement hole and screwed to the first threaded hole of the first fastening member so that the first and second fastening members are engaged with each other and the first and second fastening sides extend into the auxiliary handle fixing passage to fasten the auxiliary handle.

2. The hidden fixing device for a bike auxiliary handle as claimed in claim 1, wherein the displacement hole between the first and second accommodation recesses at the front and rear ends of the side of the auxiliary handle fixing passage is in an oval shape.
